(19) United States
(12) Patent Application Publication
(10) Pub. No.: US 2026/0340436 A1
(43) Pub. Date: Oct. 29, 2026

(54) AGGREGATED NODE MAP MULTI-DIRECTIONAL EDGES

(71) Applicant: ServiceNow, Inc., Santa Clara, CA (US)

(72) Inventors: Anusha Mallesh Tigali, Bengaluru (IN); Aditi Agarwal Kalani, Pune (IN)

(21) Appl. No.: 19/192,744

(22) Filed: Apr. 29, 2025

(51) Int. Cl. G06N 5/022; G06T 11/26

(52) U.S. Cl. CPC G06N 5/022; G06T 11/26

(57) ABSTRACT

Embodiments of the subject technology relate to systems, methods, and computer-readable media for generating knowledge graphs and graphical representations of knowledge graphs. Relational data indicative of a plurality of connections between a first node and a second node can be obtained. A first aggregated connection between the first node and the second node can be generated by aggregating a first subset of the plurality of connections with each other. A graphical representation of a knowledge graph indicative of the first aggregated connection can be generated.

### BACKGROUND

### 1. Technical Field

The present disclosure generally relates to knowledge graph generation, and more specifically to generating graphical representation of knowledge graphs.

### 2. Introduction

A knowledge graph represents data and relationships between the data. The knowledge graph can become more complex as more data is included in the graphs and different relationships between the data are included in the graph. As a result, interpreting the knowledge graph is often difficult and computationally expensive.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more embodiments, components, devices, nodes, systems, instances, and/or portions of the example cloud computing architecture, according to some examples of the present disclosure;

FIG. 2 illustrates a schematic diagram of an architecture for maintaining a knowledge graph and generating a graphical representation of the knowledge graph, according to some examples of the present disclosure;

FIG. 3 illustrates an example graphical representation of a knowledge graph, according to some examples of the present disclosure;

FIG. 4 illustrates another example graphical representation of the knowledge graph, according to some examples of the present disclosure;

FIG. 5 illustrates a flowchart of an example method of building and updating a knowledge graph through aggregated connections, according to some examples of the present disclosure;

FIG. 6 illustrates a flowchart of an example method of maintaining a graphical representation of a knowledge graph that includes indications of directionality of connections in an aggregated connection, according to some examples of the present disclosure; and

FIG. 7 illustrates an example processor-based system with which some embodiments of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Knowledge graphs indicate entities, otherwise data or knowledge, and relationships between the entities. As a knowledge graph grows in complexity, interpreting the graph—e.g., to make logical inferences—becomes more difficult and computationally expensive. Specifically, as the number of nodes in the graph increases and the number of edges between the nodes increases, it becomes difficult to correctly interpret the information represented in the graph and make logical inferences from the graph. For example, as the number of edges between the nodes increases it becomes more difficult to adequately describe or name the edges in the graph to semantically represent the corresponding relationships between the nodes.

The disclosed technology addresses the foregoing by grouping different relationships between nodes in a knowledge graph. Representations of the groupings of the relationships can initially be displayed instead of showing edges corresponding to every relationship between the nodes. In turn, a representation of one of the groupings can be activated to display the edges within the grouping, effectively zooming in/focusing on the relationships in the grouping. As a result, different edges/relationships between nodes can be represented in a clearer/uncluttered manner, thereby facilitating the formation of inferences from information semantically represented in the knowledge graph.

Further, as the knowledge graph grows in complexity, it becomes more difficult to represent the directionality aspect of the relationships between the nodes in the graph. In particular, when relationships are bidirectional, it is difficult to show the bidirectionality in the graph when the number of edges between the nodes increases. The disclosed technology addresses the foregoing by abstaining from showing directionality of relationships between the nodes when showing the representations of the individual relationships. Instead, the directionality can be shown with respect to groupings of relationships. For example, the directionality can be shown when a specific grouping of the relationships is focused on, e.g. through activation of a representation of the grouping. As a result, directionality of relationships can be represented in a clearer manner in the knowledge graph, thereby further facilitating the formation of inferences from the graph based on the directionality of the relationships.

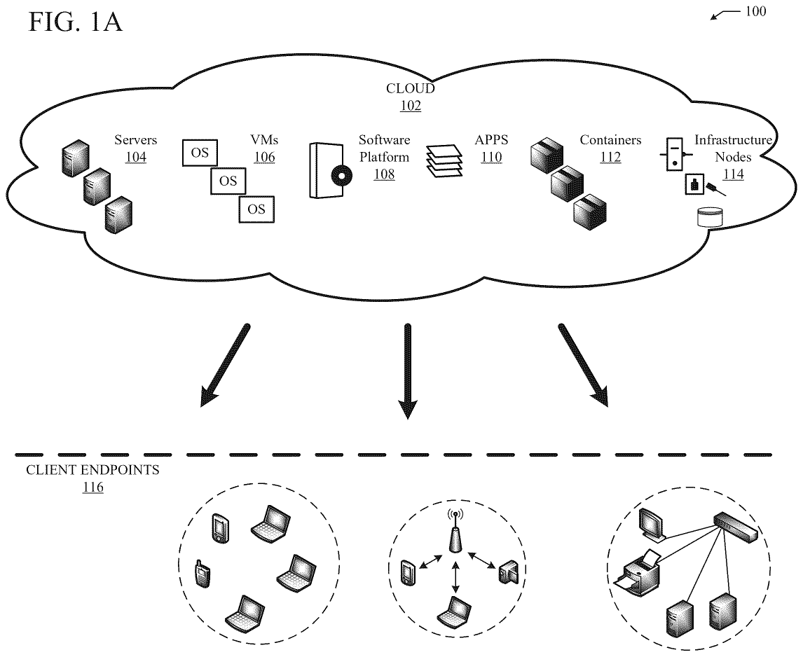

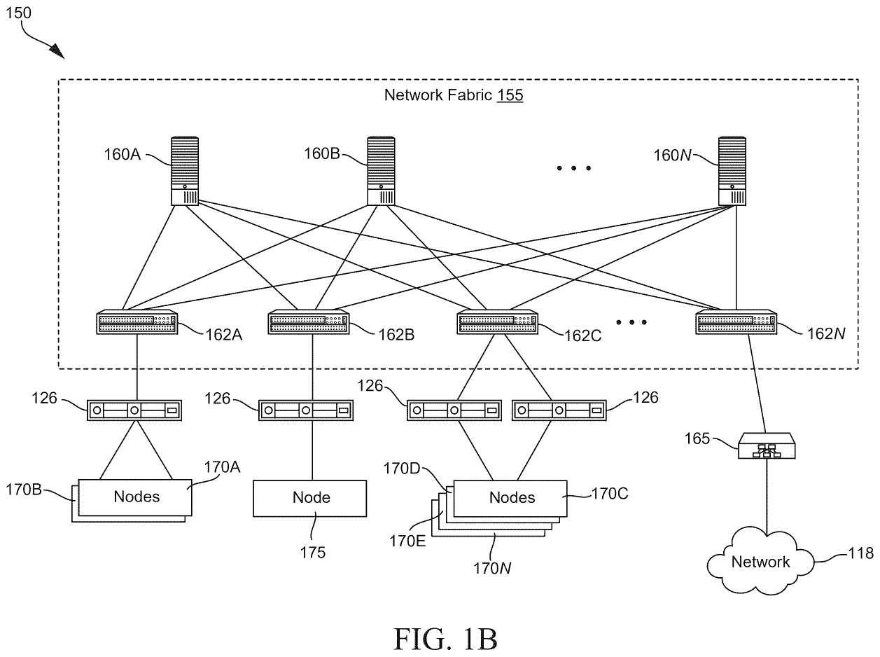

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, or any smart or connected object (e.g., smart home, smart building, smart retail, smart glasses, etc.), and so forth.

In some cases, one or more embodiments, components, devices, nodes, systems, instances, and/or portions of the example cloud 102 can be implemented by and/or in a cloud network or datacenter. For example, any portion (or all) of the network 118, any of the content servers 120 (or all), and/or any of the system servers 126 (or all) can be implemented by and/or in a cloud network or datacenter. An example network architecture that can be used to implement any such network or datacenter (or any portion thereof), is shown in FIG. 1B and further described below.

FIG. 1B is a block diagram illustrating an example network architecture 150 that can be used to implement one or more embodiments, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

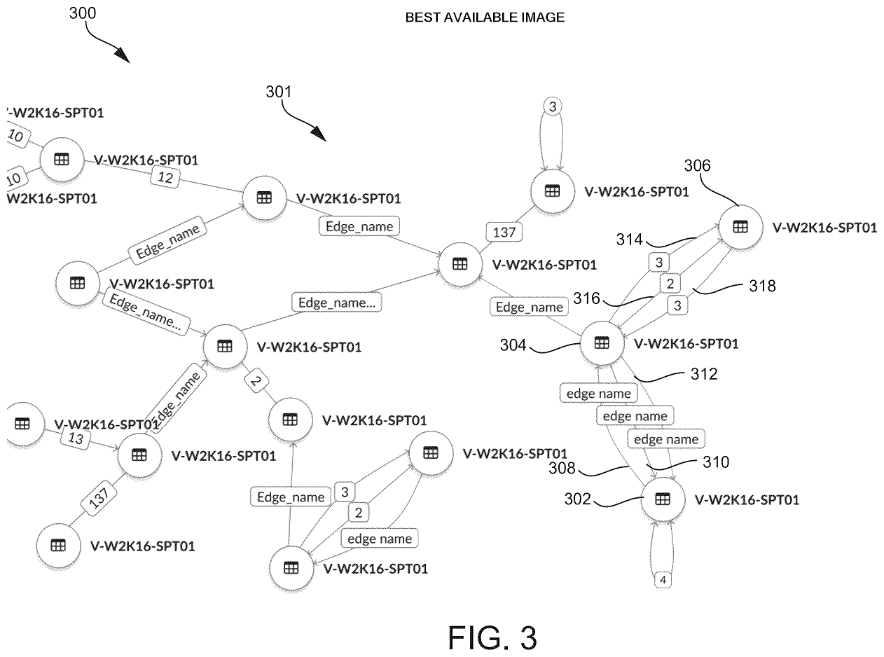

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes, such as the worker nodes and the master node shown in FIG. 3 (and further described below). In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some embodiments, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

Various embodiments of the subject technology can be implemented through the cloud computing architecture 100 shown in FIG. 1A and the network architecture 150 shown in FIG. 1B.

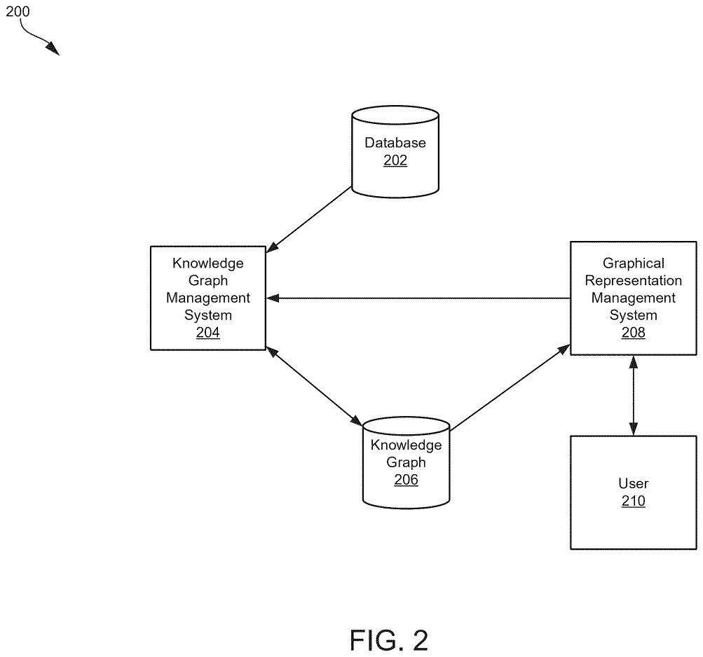

FIG. 2 illustrates a schematic diagram of an architecture 200 for maintaining a knowledge graph and generating a graphical representation of the knowledge graph, according to some examples of the present disclosure. The architecture 200 comprises a database 202, a knowledge graph management system 204, a knowledge graph datastore 206, a graphical representation management system 208 and a user 210.

The database 202 functions to store data that can be represented in a knowledge graph. A knowledge graph, as used herein, is a structure in which data can be represented and organized to show representations of the data and relationships between the data. As described previously, knowledge graphs indicate entities, otherwise data or knowledge, and relationships between the entities. Specifically, a knowledge graph can organize subsets of knowledge in one or more topical domains and the relationships between the subsets of knowledge in a graphical form. The subsets of knowledge can be referred to as nodes in a knowledge graph. Relationships between the subsets of knowledge are sometimes referred to as edges when represented in the graphical form of the knowledge graph. In turn, the graphical form can be interpreted by humans and machines in making logical inferences based on the representations of the subsets of knowledge and the relationships between them and semantic meaning of the representations of the subsets and the relationships in the knowledge graph.

A knowledge graph can be associated with, or otherwise make use of, an ontology that facilitates the making of logical inferences from the knowledge graph. Specifically, an ontology can serve as a semantic layer associated with data that serves as a framework for organizing data into nodes in the knowledge graph. Further, the ontology can serve as a framework for defining relationships between the nodes in the knowledge graph. As follows, logical inferences can be made from the knowledge graph based on the ontology that is used in organizing the data and defining relationships in the knowledge graph.

The database 202 functions to store applicable data that can be represented in a knowledge graph. Specifically, the database 202 can store structured data, unstructured data, and data that is connected through relationships/relations. Data stored in the database 202 can be specific to a single enterprise or span multiple enterprises. In turn, a knowledge graph that is created from the data can be specific to an enterprise or span across multiple enterprises.

The knowledge graph management system 204, functions to maintain a knowledge graph that is stored as knowledge graph data in the knowledge graph datastore 206. Specifically, the knowledge graph management system 204 can maintain a knowledge graph based on data stored in the database 202. In maintaining a knowledge graph, the knowledge graph management system 204 can generate a new knowledge graph, e.g. from data stored in the database 202. Further, in maintaining a knowledge graph, the knowledge graph management system 204 can update an already existing knowledge graph. Specifically, the knowledge graph management system 204 can update a knowledge graph based on either or both new data or input, e.g. received from the user 210.

The knowledge graph management system 204 can maintain a knowledge graph according to an ontology. The ontology can be specific to a domain of data that is included in the knowledge graph. For example, an ontology can be specific to the healthcare industry. As follows, the knowledge graph management system 204 can be apply the ontology in generating a knowledge graph for data associated with the healthcare industry. Further the ontology can be specific to an entity/enterprise associated with the data. For example, an ontology can be specific to a sales group of an enterprise. In turn, the knowledge graph management system 204 can apply the ontology to generate a knowledge graph for the sales group.

In maintaining a knowledge graph for data, the knowledge graph management system 204 can define nodes in the knowledge graph that are representative of different subsets of the data. Specifically, the knowledge graph management system 204 can define nodes from data based on an applied ontology. For example, the knowledge graph management system 204 can define nodes that represent different entities in an organization based on an ontology. Further, in maintaining the knowledge graph, the knowledge graph management system 204 can define, or otherwise identify, relationships between the subsets of data represented by different nodes in the knowledge graph. As follows, the knowledge graph management system 204 can define edges based on the identified relationships. Specifically, the knowledge graph management system 204 can define relationships and edges corresponding to the relationships in the knowledge graph based on the applied ontology. For example, the knowledge graph management system 204 can define relationships between the different entities in the organization as edges in the knowledge graph.

The knowledge graph management system 204 can label the nodes and edges in the knowledge graph. In labeling the nodes and edges, the knowledge graph management system 204 can label the nodes and edges with morphemes and words that semantically represent the nodes and edges. Specifically, the knowledge graph management system 204 can label the nodes with words and morphemes that semantically represent the data that is represented by the node. For example, a node that is representative of data associated with a new business sales group can be labeled as “new business sales.” In another example, a node that is representative of new business leads can be labeled as “new business leads.” The knowledge graph management system 204 can also label the edges with words and morphemes that semantically represent the relationships that are represented by the edges. For example, the knowledge graph management system 204 can label the relationships that connect new business leads in the “new business leads” node to team members in the “new business sales” node.

In maintaining the knowledge graph, the knowledge graph management system 204 can aggregate connections/relationships between nodes in the knowledge graph. In various embodiments, the knowledge graph management system 204 can aggregate edges representing the connections/relationships as part of aggregating the connections between the nodes. The knowledge graph management system 204 can aggregate the connections based on one or more applicable factors that can be used in grouping connections between nodes in a knowledge graph. Specifically, the knowledge graph management system 204 can group the connections based on logical similarity between the connections. For example, the knowledge graph management system 204 can group the connections based on logical similarity in the semantic meanings of the labels assigned to the connections. More specifically, the knowledge graph management system 204 can group the connections based on semantic contexts associated with the labels of the connections. Semantic context, as used herein, can comprise the meaning of words and phrases based on surrounding factors, such as contextual clues, syntax, and the intended meaning of the labels.

As follows, the knowledge graph management system 204 can maintain the knowledge graph to represent the aggregated connections between nodes. Specifically, the knowledge graph management system 204 can define an edge between nodes in the knowledge graph that represents a first subset of aggregated connections between the nodes. As follows, the knowledge graph management system 204 can define another edge between the nodes that represents a second subset of aggregated connections between the nodes. For example, the knowledge graph management system 204 can define an edge for a first group of aggregated connections of previous employee contacts between the “new business sales” node and the “new business leads” node in the knowledge graph. Further in the example, the knowledge graph management system 204 can define an edge for a second group of aggregated connections of cold call contacts between the “new business sales” node and the “new business leads” node in the knowledge graph.

The knowledge graph management system 204 can assign labels to the edges representing aggregated connections in the knowledge graph. Specifically, the knowledge graph management system 204 can assign labels to the edges representing the aggregated connections that have semantic meaning related to the aggregated connections. For example, the knowledge graph management system 204 can label an edge representing aggregated connections of cold call contacts as “cold call connections.”

In maintaining the knowledge graph, the knowledge graph management system 204 can define directional values of connections and aggregated connections represented in the knowledge graph, e.g. through edges. A directional value of a connection indicates both that the connection is a directional relationship and one or more directions of the relationship. A directional value of an aggregated connection can indicate that a connection in the aggregated connection is a directional relationship and one or more directions of the relationship. A relationship can be a unidirectional relationship in which one or more characteristics of the relationship are defined by a specific direction. For example, a unidirectional relationship in a supply chain that points from a first entity to a second entity can signify that the first entity supplies the second entity while the second entity does not supply the first entity. Further, a relationship can be a multidirectional relationship in which one or more characteristics of the relationship are defined by more than one direction. For example, a multidirectional relationship in the supply chain that points between the first entity and the second entity can signify that the first entity supplies the second entity while the second entity supplies the first entity.

The graphical representation management system 208 functions to generate a graphical representation of the knowledge graph maintained by the knowledge graph management system 204. Specifically, the graphical representation management system 208 can generate a graphical representation of the knowledge graph from knowledge graph data stored in the knowledge graph datastore 206. As follows, the graphical representation management system 208 can present, or otherwise facilitate presentation of, the graphical representation of the knowledge graph to the user 210. For example, the user 210 can be interacting with a client device and the graphical representation management system 208 can send data indicative of the graphical representation to the client device. In turn, the client device can reproduce the graphical representation for the user 210 from the received data.

The user 210 can provide input to the graphical representation management system 208, e.g. through the client device. Specifically, the user 210 can provide input to the graphical representation management system 208 based on interacting with the graphical representation of the knowledge graph. The input can be applicable feedback that the user 210 can provide in response to interacting with the representation of the knowledge graph. Specifically, the input can specify updating the graphical representation of the knowledge graph to change the graphical representation of the knowledge graph. For example, the input can specify activating an edge representing an aggregated connection between nodes to zoom into the aggregated connection or otherwise list the connections in the aggregated connection. In another example, the input can specify representing the group of aggregated connections as a single connection between the nodes.

The graphical representation management system 208 can update the graphical representation of the knowledge graph based on the input provided by the user 210. Specifically, the graphical representation management system 208 can modify the graphical representation of the knowledge graph based on the input. For example, the graphical representation management system 208 can modify the graphical representation to list all of the connections in an aggregated connection based on the input. In another example, the graphical representation management system 208 can modify the graphical representation to only display a single edge as representing all connections within an aggregated connection. As follows, the graphical representation management system 208 can facilitate display of the modified graphical representation to the user 210.

The graphical representation management system 208 can provide received input from the user 210 the knowledge graph management system 204. In turn, the knowledge graph management system 204 can change or otherwise update the knowledge graph based on the input received from a user. Specifically, the input received from the user 210 can specify changes to make to the knowledge graph itself, and not just the graphical representation of the knowledge graph. For example, the input can specify to remove a connection between nodes or remove a connection from a group of aggregated connections. In turn, the knowledge graph management system 204 can modify the knowledge graph to reflect the changes to the knowledge graph specified by the user 210.s.

FIG. 3 illustrates an example graphical representation 300 of a knowledge graph 301, according to some examples of the present disclosure. The knowledge graph 300 can be created according to an applicable ontology using applicable data. The knowledge graph 300 comprises a first node 302, a second node 304, and a third node 306.

In the knowledge graph 301, the first node 302 and the second node 304 have three connections (otherwise edges), a first connection 308, a second connection 310, and a third connection 312. The connections 308, 310, and 312 correspond to different relationships between the first node 302 and the second node 304. Each of the connections 308, 310, and 312 is represented by a separate edge. As shown in FIG. 3, if more connections existed between the first node 302 and the second node 304, and an edge was shown to represent each connection between the nodes, then it would become more and more difficult to adequately display the connections between the first node 302 and the second node 304 in the graphical representation 300. In particular, edges would be moved closer to each other as the number of connections grow, making it more difficult to distinguish the edges, visualize the connections, and fit labels assigned to each of the connections.

As shown in FIG. 3, the connections 308, 310, and 312 all have directional values that indicate the direction of the connections 308, 310, and 312. Specifically, the connections 308, 310, and 312 have arrows at the end of the corresponding edges to show the directionality of each of the connections 308, 310, and 312. For example, the first connection 308 has an arrow pointing to the second node 304 at the end of the edge leading into the second node 304. This signifies that the connection 308 is a unidirectional relationship from the first node 302 to the second node 304. Further in the graphical representation 300, the second and third connections 310 and 312 have arrows pointing to the first node 310 at the end of the edges leading into the first node 302. This signifies that the connections 310 and 312 are unidirectional relationships from the second node 304 to the first node 302. As more edges are added representing each connection, the arrows that signify directionality of the connections can overlap. In turn, this can make it difficult to determine whether such arrows are present on an edge-by-edge, otherwise connection-by-connection, basis. This can make it difficult to determine the directionality of each of the connections between the first node 302 and the second node 304, and thereby properly interpret the knowledge graph 301.

In the graphical representation 300 shown in FIG. 3, the second node 304 and the third node 306 are connected by a first group of aggregated connections 314, a second group of aggregated connections 316, and a third group of aggregated connections 318. The aggregated connections 314, 316, and 318 can comprise connections that are aggregated together based on one or more applicable characteristics of the connections. Specifically, the corresponding connections that form the aggregated connections 314, 316, and 318 can be grouped based on logical similarity. Further, the corresponding connections that form the aggregated connections 314, 316, and 318 can be grouped based on semantic meaning of labels or other representations of the relationships in the knowledge graph 301. For example, all connections that have labels that are semantically indicative of a patient doctor relationship can be grouped together.

As shown in the graphical representation 300, each of the aggregated connections 314, 316, and 318 can be represented by a single edge. Further, the number of connections in each of the aggregated connections 314, 316, and 318 can be displayed in relation to the edge representing each of the aggregated connections 314, 316, and 318. For example, the first aggregated connection 314 is formed by three connections and a “3” is placed over the edge, the second aggregated connection 316 is formed by two connections and a “2” is placed over the edge, and the third aggregated connection 318 is formed by three connections and a “3” is placed over the edge.

In grouping connections into aggregated connections and representing each aggregated connection as a single edge, only three connection representations are shown between the second and third nodes 304 and 306. Specifically, there are 8 connections between the second and third nodes 304 and 306. If each of these connections was simultaneously represented by a single edge, then there would be 8 edges connecting the second and third nodes 304 and 306. Showing this many connections simultaneously would make it difficult to adequately represent every connection in the graphical representation 300. In particular, this would make it difficult to visualize the connections if labels for each of the connection are included in the graphical representation 300. Further, this many connections shown simultaneously would make it difficult to adequately display each of the connections and corresponding directional values with each of the connections, e.g. as the directional value indicators could overlap.

The aggregated connections can be associated with a directional value. Specifically, the first aggregated connection 314 is associated with a directional value pointing from the second node 304 to the third node 306. The second aggregated connection 316 is associated with a directional value pointing from the second node 304 to the third node 306. The third aggregated connection 318 is associated with a directional value pointing form third node 306 to the second node 304. A directional value of an aggregated connection can correspond to a direction of one or more connections in the aggregated connection. Specifically, the directional value can correspond to the direction of a majority or half of the connections in the aggregated connection.

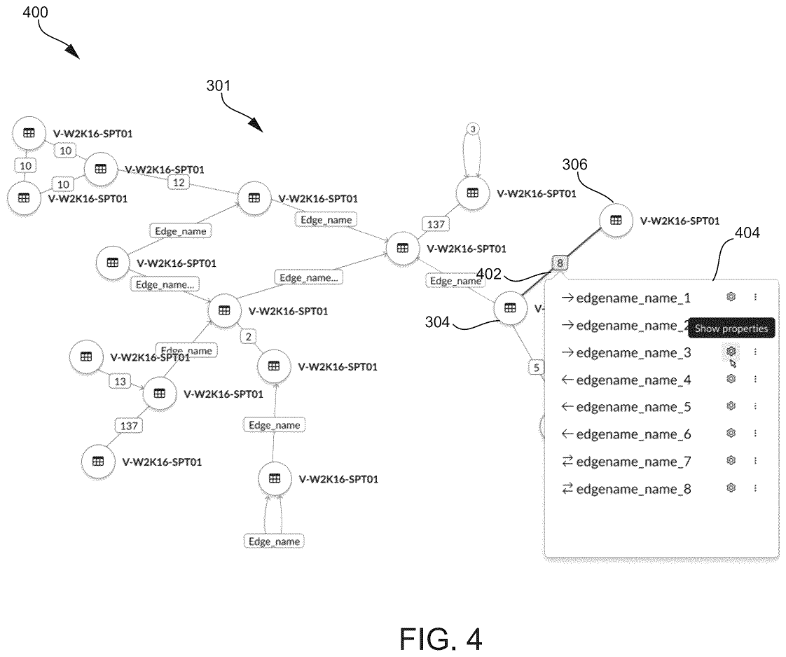

FIG. 4 illustrates another example graphical representation 400 of the knowledge graph 301, according to some examples of the present disclosure. As discussed previously, the knowledge graph 300 comprises the second node 304 and the third node 306. As shown in the graphical representation 400 in FIG. 4, the aggregated connections between the second node 304 and the third node 306 have been further aggregated into a single aggregated connection 402. The aggregated connection 402 is represented by a single edge and also includes a numerical value, “8”, indicating the number of connections in the aggregated connection 402.

The graphical representation comprises a snapshot 404 of the connections in the aggregated connection 402. The snapshot 404 can be activated by interacting with the graphical representation in an applicable manner. Specifically, the snapshot 404 can be activated by interacting with the edge representing the aggregated connection 402. The snapshot 404 can identify each of the connections in the aggregated connection 402. Specifically, the snapshot 404 can comprise a label assigned to each of the connections in forming the knowledge graph 301. In displaying the label assigned to each of the connections, an operator or machine can interpret the semantic meaning associated with the labels to identify characteristics of the relationships represented by the connections. Further, displaying the connections with associated labels in a list in the snapshot 404 makes visualization of each of the connections and corresponding labels easier in comparison to if each of the connections was represented with an edge and a corresponding superimposed label.

The snapshot 404 also comprises directional values that indicate directionality of each of the connections. The directional values are represented by indicators, otherwise arrows. In instances where the directionality of a connection is bidirectional, the directional value of the connection is shown by two opposing arrows. For example, connection “edgename_name_8” has a directional value of two opposing arrows to show the bidirectionality of the connection. Showing the directional values of the connections in the snapshot 404, as opposed to in a corresponding edges representation of each of the connections, is advantageous as each of the indicators of the directional values can be distinctly visualized. In turn, this can facilitate easy interpretation of the directional values by either or both an operator or a machine.

The graphical representation 400 of the workflow 301 shown in FIG. 4 can be generated based on received input. Specifically, the graphical representation 400 of the workflow 301 can be generated based on input generated and received from a user based on their interaction with the graphical representation 300 of the workflow 310 shown in FIG. 3. For example, a user can interact with the aggregated connections 314, 316, and 318 between the second node 304 and the third node 306 in the graphical representation 300 of the workflow 301. In turn, user input indicating to combine the aggregated connections 314, 316, and 318 and display a snapshot of the connections can be generated and sent to the graphical representation management system 208. The graphical representation management system 208 can then generate the graphical representation 400 of the workflow 301 that includes the aggregated connection 402 and the snapshot 404 of the connections in the aggregated connection 402.

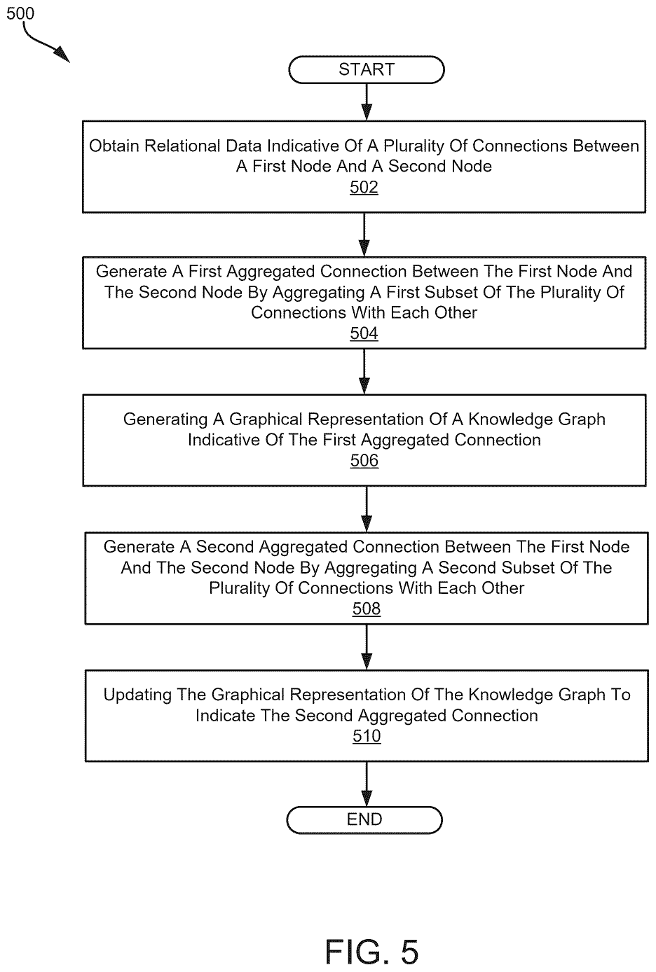

The disclosure now continues with a discussion of techniques for generating graphical representations of knowledge graphs. FIG. 5 illustrates a flowchart 500 of an example method of building and updating a knowledge graph through aggregated connections, according to some examples of the present disclosure. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method. The modules will be discussed with respect to the example architectures described herein.

At module 502, relational data indicative of a plurality of connections between a first node and a second node is obtained. Relational data can be included as part of the data that is used in generating a knowledge graph. Specifically, relational data can include applicable data describing relations between different subsets of data that form nodes in the knowledge graph. Relational data can describe the relationships so that labels that are semantical representations/descriptions of the relationships can be assigned to the relationships in the knowledge graph. Further, the relational data can include labels that are semantical representations of the relationships, e.g. that have already been generated for and associated with the relationships.

At module 504, a first aggregated connection is generated between the first node and the second node by aggregating a first subset of the plurality of connections with each other. The subset of the plurality of connections can be aggregated according to applicable characteristics of the connections. Specifically, the subset of the plurality of connections can be aggregated based on logical similarity between the connections and semantic representations of the connections, such as labels assigned to the connections, e.g. in a knowledge graph. For example, the labels assigned to the connections in the knowledge graph can be semantically analyzed to determine characteristics of the relationships, both contextually and from the plain meaning of the labels. As follows, the connections can be aggregated based on logical similarity between the characteristics of the corresponding relationships.

At module 506, a graphical representation of a knowledge graph indicative of the first aggregated connection is generated. Specifically, a graphical representation of a knowledge graph that includes the connections that form the aggregated connection can be generated. The graphical representation can be generated to show the aggregated connections as a single edge within the knowledge graph. Representing the aggregated connection as a single edge in the graphical representation (e.g., in a graphical user interface (GUI)) is technically advantageous as it reduces the number of edges that are present in the graphical representation while still showing a representation of the connections in the aggregated connection. Further and as shown in the graphical representations 300 and 400 shown in FIGS. 3 and 4, the aggregated connections representation can include an indication of the number of connections in the aggregated connection. In turn, different edges/relationships between nodes can be represented in a clearer/uncluttered manner, thereby facilitating the formation of inferences from information semantically represented in the knowledge graph. Moreover, representing edges and relationships between nodes more clearly (e.g., a less cluttered GUI) enables a user to more efficiently interact with the graphical representation. For example, a less cluttered GUI may result in fewer user inputs in connection with the user attempting to select a particular edge or node. Fewer user inputs results in less utilization of processing, display, and power resources.

At module 508, a second aggregated connection between the first node and the second node is generated by aggregating a second subset of the plurality of connections with each other. The second subset of the plurality of connections can comprise connections that are distinct from the connections that form the first subset of the plurality of connections. Accordingly, the first and second subsets of the plurality of connections can be distinct from each other. The second aggregated connection can be generated in the same manner in which the first aggregated connection is created at module 504. Specifically, the second aggregated connection can be generated based on logical similarity of the connections and semantic meaning of labels of the connections in the knowledge graph.

At module 510, the graphical representation of the knowledge graph is updated to indicate the second aggregated connection. In updating the graphical representation to indicate the second aggregated connection, an indication of the first aggregated connection can be removed from the graphical representation. Specifically, the second aggregated connection can be represented as a single edge in the graphical representation while the edge corresponding to the first aggregated connection can be removed from the graphical representation. As discussed previously with respect to the first aggregated connection, representing the aggregated connection as a single edge in the graphical representation is technically advantageous as it reduces the number of edges that are present in the graphical representation while still showing a representation of the connections in the aggregated connection. In turn, this can facilitate easier interpretation of the knowledge graph and inferring information from the knowledge graph.

Alternatively, the first and second aggregated connections can be represented simultaneously in the updated graphical representation of the knowledge graph. Specifically, the first and second aggregated connections can be represented as corresponding single edge graphs in the graphical representation. Representing the first and second aggregated connections as corresponding single edges is technically advantageous as it reduces the number of edges that are present in the graphical representation while still showing a representation of the connections, e.g. when compared to a graphical representation that represents every connection as a corresponding edge. In turn, different edges/relationships between nodes can be represented in a clearer/uncluttered manner, thereby facilitating the formation of inferences from information semantically represented in the knowledge graph.

The graphical representation can be updated based on input, e.g. user or machine input. Specifically, a user can interact with the graphical representation of the knowledge graph that is generated at module 506 to generate the input. As follows, the graphical representation can be updated based on the user interactions with the graphical representation to indicate the second aggregated connection.

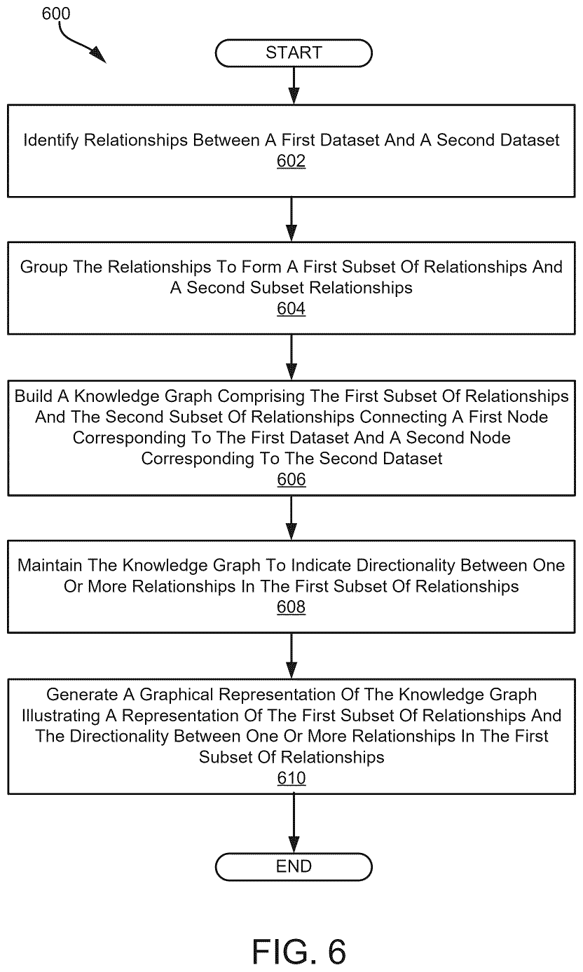

FIG. 6 illustrates a flowchart 600 of an example method of maintaining a graphical representation of a knowledge graph that includes indications of directionality of connections in an aggregated connection, according to some examples of the present disclosure. The method shown in FIG. 6 is provided by way of example, as there are a variety of ways to carry out the method. Additionally, while the example method is illustrated with a particular order of steps, those of ordinary skill in the art will appreciate that FIG. 6 and the modules shown therein can be executed in any order and can include fewer or more modules than illustrated. Each module shown in FIG. 6 represents one or more steps, processes, methods or routines in the method. The modules will be discussed with respect to the example architectures described herein.

At module 602, relationships between a first dataset and a second dataset are identified. Relationships can be identified from the datasets themselves. Specifically, relationships can be identified from labels that describe the first and second datasets, e.g. in a knowledge graph. More specifically, relationships can be identified from semantic meaning of the labels of the datasets and semantic contexts of the labels of the datasets. Further, relationships can be identified from relational data describing the first and second datasets. Specifically, relational data can described characteristics of the datasets and a context about the datasets. In turn, relationships between the datasets can be identified from the characteristics of the datasets and the context about the datasets.

At module 604, the relationships are grouped to form a first subset of relationships and a second subset of relationships. The relationships can be grouped based on logical similarity between the relationships. Specifically, the relationships can be grouped based on logical similarity between the relationships that is determined from semantics, e.g. meaning and context, in relation to the labels assigned to the relationships. The first subset and second subset of relationships can be distinct subsets that do not have any common relationships between the corresponding subsets.

At module 606, a knowledge graph is built that comprises the first subset of relationships and the second subset of relationships connecting a first node and a second node. The first node can correspond to, or otherwise represent, the first dataset and the second node can correspond to, or otherwise represent, the second dataset. The knowledge graph can comprise connecting the first subset of relationships between the first node and the second node. The knowledge can also comprise connecting the second subset of relationships between the first node and the second node. Additionally, the knowledge graph can comprise labels illustrating a semantic meaning of the first subset of relationships, connections/individual relationships in the first subset of relationships, the second subset of relationships, connections/induvial relationships in the second subset of relationships, the first dataset corresponding to the first node, and the second dataset corresponding to the second node.

At module 608, the knowledge graph is maintained to indicate directionality between one or more relationships in the first subset of relationships. Specifically, the knowledge graph can be generated or updated to comprise directional values indicative of directions of the first subset of relationships, the relationships in the first subset of relationships, the second subset of relationships, and the relationships in the second subset of relationships. Such directional values can indicate either a unidirectional relationship or a bidirectional relationship. As follows, logical inferences about the data represented in the knowledge graph can be made based on the directional values.

At module 610, a graphical representation of the knowledge graph is generated that illustrates a representation of the first subset of relationships and the directionality between one or more relationship in the first subset of relationships. Specifically, the knowledge graph can be generated or updated to show the first subset of relationships and a snapshot describing each relationship in the first subset of relationships. More specifically, the first subset of relationship can be represented as a single edge. Further, the snapshot can be distinct from the edge and can list each of the connections/relationships in the first subset of relationships. Additionally, the snapshot can indicate a directionality of each of the relationships. Representing each of the relationships in a snapshot that is separate from an edge that represents the grouped relationships is technically advantageous as the relationships and the aggregated relationships are represented in a clearer manner, as opposed to if each relationship was represented by an edge in the knowledge graph. Further, representing the directionality/directional values of the relationships in a snapshot that is separate from the edge is technically advantageous as each of the directional values can be presented in a clear manner from which logical inferences can be made. This is in contrast to representing the directional values along with a single edge representing each relationship, where often the directional values can overlap making it difficult to discern and interpret the values across the relationships. As follows, inferences can be made from the snapshot based on the directionality of the relationships in the first subset of relationships.

The graphical representation can also simultaneously display a representation of the second subset of relationships. Specifically, the graphical representation can display the second subset of relationships as an edge between the first and second nodes along the edge representing the first subset of relationships. Further, the graphical representation can display a representation of the directionality between relationships in the second subset of relationships.

In various embodiments, an applicable generative model can access a knowledge graph described herein. In turn, the generative model can interpret the graph and infer information about the data that is included in the knowledge graph. For example, a generative model can understand context from the knowledge graph in relation to a user query. In turn, the generative model can formulate a response to the query based on the context determined from the knowledge graph.

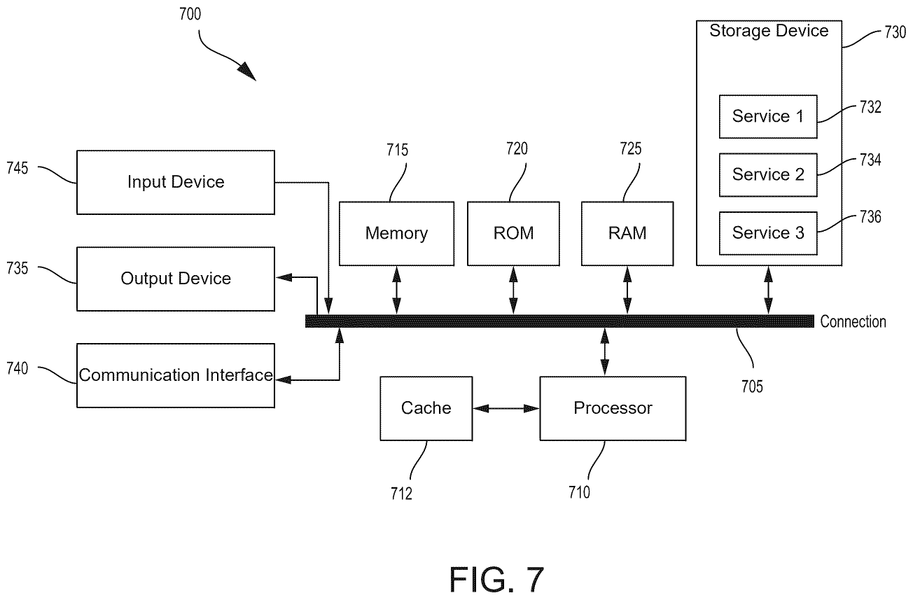

FIG. 7 illustrates an example processor-based system with which some embodiments of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Illustrative examples of the disclosure include:

Embodiment 1. A computer-implemented method comprising: obtaining relational data indicative of a plurality of connections between a first node and a second node; generating a first aggregated connection between the first node and the second node by aggregating a first subset of the plurality of connections with each other; and generating a graphical representation of a knowledge graph indicative of the first aggregated connection.

Embodiment 2. The computer-implemented method of Embodiment 1, further comprising: generating a second aggregated connection between the first node and the second node by aggregating a second subset of the plurality of connections with each other, the first aggregated connection being different from the second aggregated connection; and updating the graphical representation of the knowledge graph to indicate the second aggregated connection.

Embodiment 3. The computer-implemented method of Embodiment 2, wherein updating the graphical representation of the knowledge graph includes removing the indication of the first aggregated connection.

Embodiment 4. The computer-implemented method of either of Embodiments 2 or 3, further comprising: transmitting, to a client device, data indicative of the graphical representation of the knowledge graph indicative of the first aggregated connection; obtaining, from the client device, a request to update the graphical representation; and based on the request, updating the graphical representation of the knowledge graph to indicate the second aggregated connection.

Embodiment 5. The computer-implemented method of any of Embodiments 1 through 4, wherein each of the first subset of the plurality of connections is associated with a corresponding directionality value, and wherein generating the first aggregated connection is based on the corresponding directionality values.

Embodiment 6. The computer-implemented method of Embodiment 5, wherein the knowledge graph is indicative of a corresponding directionality value.

Embodiment 7. The computer-implemented method of Embodiment 6, wherein the directional value is unidirectional or multidirectional.

Embodiment 8. The computer-implemented method of any of Embodiments 1 through 6, wherein the knowledge graph comprises one or more semantic representations of one or more relationships between the first node and the second node.

Embodiment 9. The computer-implemented method of Embodiment 8, wherein the one or more relationships correspond to one or more connections in the first subset of the plurality of connections between the first node and the second node.

Embodiment 10. A computer-implemented method comprising: identifying relationships between a first dataset and a second dataset; grouping the relationships to form a first subset of relationships and a second subset of relationships; building a knowledge graph comprising the first subset of relationships and the second subset of relationships connecting a first node representing the first dataset and a second node representing the second dataset; and generating a graphical representation of the knowledge graph illustrating a representation of the first subset of relationships and a representation of the second subset of relationships between the first dataset and the second dataset.

Embodiment 11. The computer-implemented method of Embodiment 10, wherein the relationships comprise logical relationships between the first dataset and the second dataset and each of the relationships is capable of being represented by a corresponding edge in the knowledge graph.

Embodiment 12. The computer-implemented method of either Embodiment 10 or 11, further comprising selecting the first dataset and the second dataset to include in the knowledge graph from a plurality of datasets.

Embodiment 13. The computer-implemented method of any of Embodiments 10 through 12, further comprising updating the graphical representation to display edges corresponding to relationships in the first subset of relationships.

Embodiment 14. The computer-implemented method of Embodiment 13, wherein the edges are semantically representative of the corresponding relationships in the knowledge graph.

Embodiment 15. The computer-implemented method of Embodiment 14, further comprising: providing access to the knowledge graph to a generative model; and identifying by the generative model, a context associated with the first dataset and the second dataset based on semantic representations of the corresponding relationships in the edges of the knowledge graph.

Embodiment 16. The computer-implemented method of any of Embodiments 10 through 15, wherein the knowledge graph is indicative of a directionality of a relationship between the first dataset and the second dataset.

Embodiment 17. The computer-implemented method of Embodiment 16, wherein the directionality is unidirectional or multidirectional.

Embodiment 18. The computer-implemented method of either of Embodiments 16 or 17, further comprising updating the graphical representation to indicate the directionality of the relationship between the first dataset and the second dataset.

Embodiment 19. The computer-implemented method of any of Embodiments 10 through 18, further comprising grouping the relationships based on either or both logical similarity between the relationships and semantic meaning of representations of the relationships.

Embodiment 20. A system comprising: one or more processors; and at least one computer-readable storage medium having stored therein instructions which, when executed by the one or more processors, cause the one or more processors to: obtain relational data indicative of a plurality of connections between a first node and a second node; generate a first aggregated connection between the first node and the second node by aggregating a first subset of the plurality of connections with each other; and generate a graphical representation of a knowledge graph indicative of the first aggregated connection.

Embodiment 21. A system comprising means for performing a method according to any of Embodiments 1 through 19.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
obtaining relational data indicative of a plurality of connections between a first node and a second node;
generating a first aggregated connection between the first node and the second node by aggregating a first subset of the plurality of connections with each other; and
generating a graphical representation of a knowledge graph indicative of the first aggregated connection.

2. The method of claim 1, further comprising:
generating a second aggregated connection between the first node and the second node by aggregating a second subset of the plurality of connections with each other, the first aggregated connection being different from the second aggregated connection; and
updating the graphical representation of the knowledge graph to indicate the second aggregated connection.

3. The method of claim 2, wherein updating the graphical representation of the knowledge graph includes removing the indication of the first aggregated connection.

4. The method of claim 2, further comprising:
transmitting, to a client device, data indicative of the graphical representation of the knowledge graph indicative of the first aggregated connection;
obtaining, from the client device, a request to update the graphical representation; and
based on the request, updating the graphical representation of the knowledge graph to indicate the second aggregated connection.

5. The method of claim 1, wherein each of the first subset of the plurality of connections is associated with a corresponding directionality value, and wherein generating the first aggregated connection is based on the corresponding directionality values.

6. The method of claim 5, wherein the knowledge graph is indicative of a corresponding directionality value.

7. The method of claim 6, wherein the directional value is unidirectional or multidirectional.

8. The method of claim 1, wherein the knowledge graph comprises one or more semantic representations of one or more relationships between the first node and the second node.

9. The method of claim 8, wherein the one or more relationships correspond to one or more connections in the first subset of the plurality of connections between the first node and the second node.

10. A computer-implemented method comprising:
identifying relationships between a first dataset and a second dataset;
grouping the relationships to form a first subset of relationships and a second subset of relationships;
building a knowledge graph comprising the first subset of relationships and the second subset of relationships connecting a first node representing the first dataset and a second node representing the second dataset; and
generating a graphical representation of the knowledge graph illustrating a representation of the first subset of relationships and a representation of the second subset of relationships between the first dataset and the second dataset.

11. The computer-implemented method of claim 10, wherein the relationships comprise logical relationships between the first dataset and the second dataset and each of the relationships is capable of being represented by a corresponding edge in the knowledge graph.

12. The computer-implemented method of claim 10, further comprising selecting the first dataset and the second dataset to include in the knowledge graph from a plurality of datasets.

13. The computer-implemented method of claim 10, further comprising updating the graphical representation to display edges corresponding to relationships in the first subset of relationships.

14. The computer-implemented method of claim 13, wherein the edges are semantically representative of the corresponding relationships in the knowledge graph.

15. The computer-implemented method of claim 14, further comprising:
providing access to the knowledge graph to a generative model; and
identifying by the generative model, a context associated with the first dataset and the second dataset based on semantic representations of the corresponding relationships in the edges of the knowledge graph.

16. The computer-implemented method of claim 10, wherein the knowledge graph is indicative of a directionality of a relationship between the first dataset and the second dataset.

17. The computer-implemented method of claim 16, wherein the directionality is unidirectional or multidirectional.

18. The computer-implemented method of claim 16, further comprising updating the graphical representation to indicate the directionality of the relationship between the first dataset and the second dataset.

19. The computer-implemented method of claim 10, further comprising grouping the relationships based on either or both logical similarity between the relationships and semantic meaning of representations of the relationships.

20. A system comprising:
one or more processors; and
at least one computer-readable storage medium having stored therein instructions which, when executed by the one or more processors, cause the one or more processors to:
obtain relational data indicative of a plurality of connections between a first node and a second node;
generate a first aggregated connection between the first node and the second node by aggregating a first subset of the plurality of connections with each other; and
generate a graphical representation of a knowledge graph indicative of the first aggregated connection.
